(19) United States
(12) Patent Application Publication
(10) Pub. No.: US 2001/0007139 A1
(43) Pub. Date: Jul. 5, 2001

(54) Computer system and program for use in analysing data patterns

(76) Inventor: David Murray, Gort (IE)

Correspondence Address: Porter, Wright, Morris & Arthur LLP, Attn: Intellectual Property Department, 28th Floor, 41 South High Street, Columbus, OH, 43215-6194, US

(21) Appl. No.: 09/746,306

(22) Filed: Dec. 21, 2000

(30) Foreign Application Priority Data
Jan. 4, 2000 (IE) S2000/0005

(51) Int. Cl. G06F 11/26

(52) U.S. Cl. 714/26

(57) ABSTRACT

A computer system for defining and analysing data patterns enables a user to specify, by interaction with a graphical display 4 on a computer display screen 1, a plurality of different basic pattern elements ST and a plurality of different patterns SP or PD. Patterns may include low level patterns which contain only one or more basic pattern elements ST and high level patterns which contain one or more other patterns SP or PD and, optionally, one or more basic pattern elements. The user is also able to specify allowable transitions 14, 15, if any, between the basic pattern elements and patterns. Any pattern selected by the user can be compiled into a hierarchical tree wherein all leaf modes are basic pattern elements and all branch nodes are patterns which contribute, directly or indirectly, to the pattern being compiled.

This invention relates to a computer system and program for use in defining and analysing data patterns. The invention has particular, though not exclusive, application to the analysis of state machine activity in the verification of hardware logic.

The verification of hardware logic has become the bottleneck of hardware logic design. In recent years verification takes over 50% of a logic design schedule. Hardware designs have become more complex and there are individuals and companies looking for solutions and tools to make the process less complex and more intuitive.

Recent graphical tools allow designers high levels of abstraction, so they can now design some complex aspects of hardware with what are called State Machine Editors. Rather than connecting logic gates together, such tools allow the user to describe functionality at a higher level using graphical techniques. The tool then generates HDL (Hardware description Language) code automatically, from which it is possible to derive hardware netlists in conventional manner. Netlists are used by hardware manufacturers to build the actual hardware logic.

Once the design has been entered into the computer, it needs to be tested. The computer basically has a model of the hardware system so it is possible to test the model before any hardware is actually built. This process is called verification.

This verification can be very complex and there are various methodologies that help to ensure that the hardware logic is tested to the maximum. One aspect of a verification methodology is called coverage.

In recent times, coverage really meant code coverage. This methodology applied to the HDL code. The main technique was to run simulations and the coverage tool then reported all the lines of code that were not tested in the simulation. This was good feedback to the user because the could then write new tests to ‘exercise’ the untested code.

However, because the level of abstraction of design entry has changed, so too has the level of abstraction for the verification. The graphical entry tools allow one to design at the functional level, rather than writing code. This is the desired path for verification also, to be able to provide coverage for functions. This concept is called functional coverage.

Functional coverage works with hardware simulation. Hardware simulation is as follows:

the user applies stimulus to a model

the hardware model reacts and produces results

these results are checked either interactively or at a later stage to see if they conform to a functional specification.

With simulation, some of the internal workings of the hardware model are probed. For functional coverage, these internal elements would mostly be the state machines (also called finite state machines, or FSMs). These state machines are the hardware representation of logical flow diagrams.

Functional coverage allows us to link specific state machine sequences (or state sequences) with specific functions. In this way, a simulation can be turned from low-level state transitions to higher-level functions by analysing these sequences. The user can then see what functions have been tested.

It is an object of the present invention to provide a computer system and program for use in analysing data patterns, in particular but not exclusively for the analysis of state machine output in the verification of hardware logic.

According to the present invention there is provided a computer system for defining and analysing data patterns, the system comprising means to enable a user to specify, by interaction with a graphical display on a computer display screen:

(a) a plurality of different basic pattern elements, and

(b) a plurality of different patterns including low level patterns which contain only one or more basic pattern elements and high level patterns which contain one or more other patterns and, optionally, one or more basic pattern elements, the user also being able to specify allowable transitions, if any, between the basic pattern element(s) and/or pattern(s) in a pattern,

the system further including means for compiling any such pattern into a hierarchical tree wherein all leaf modes are basic pattern elements and all branch nodes are contributory patterns.

In this context, a contributory pattern is any pattern which, directly or indirectly, contributes to the pattern being compiled.

Preferably the system further enables the user to specify a plurality of different pattern groups each containing one or more basic pattern elements and/or one or more patterns and all possible transitions between them, and to specify patterns by selection from a pattern group.

The invention further provides a computer program comprising program code recorded on a computer readable medium, such code when run on a computer causing the computer to enable a user to specify, by interaction with a graphical display on a computer display screen:

(a) a plurality of different basic pattern elements, and

(b) a plurality of different patterns including low level patterns which contain only one or more basic pattern elements and high level patterns which contain one or more other patterns and, optionally, one or more basic pattern elements, the user also being able to specify allowable transitions, if any, between the basic pattern element(s) and/or pattern(s) in a pattern,

the code further including means for compiling any such pattern selected by the user into a hierarchical tree wherein all leaf modes are basic pattern elements and all branch nodes are contributory patterns.

An embodiment of the invention will now be described, by way of example, with reference to the accompanying drawings, in which:

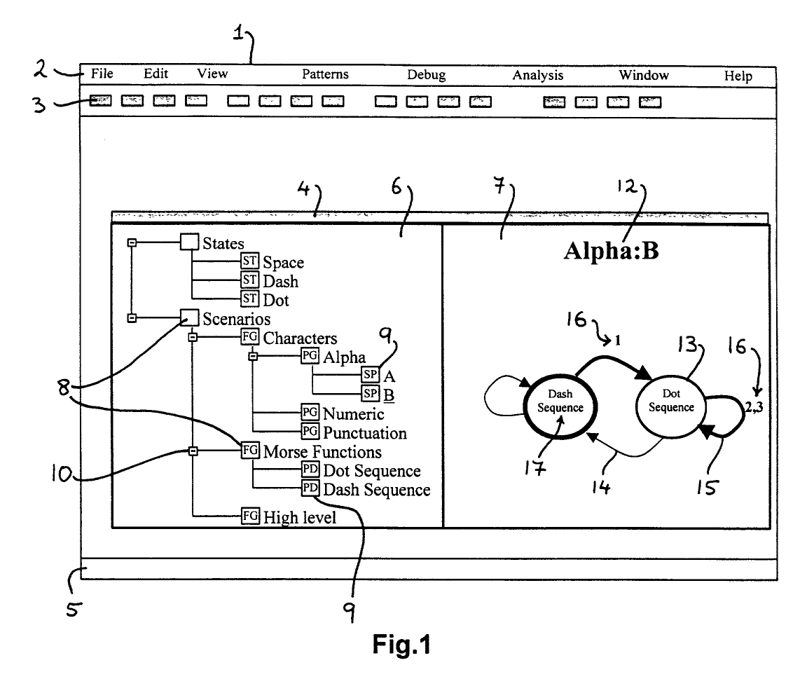

FIG. 1 shows the main window, as seen by the user, of a computer program which can be run on a conventional computer system to provide a system for use in the analysis of data patterns, in the present embodiment the functionality of Morse code; and

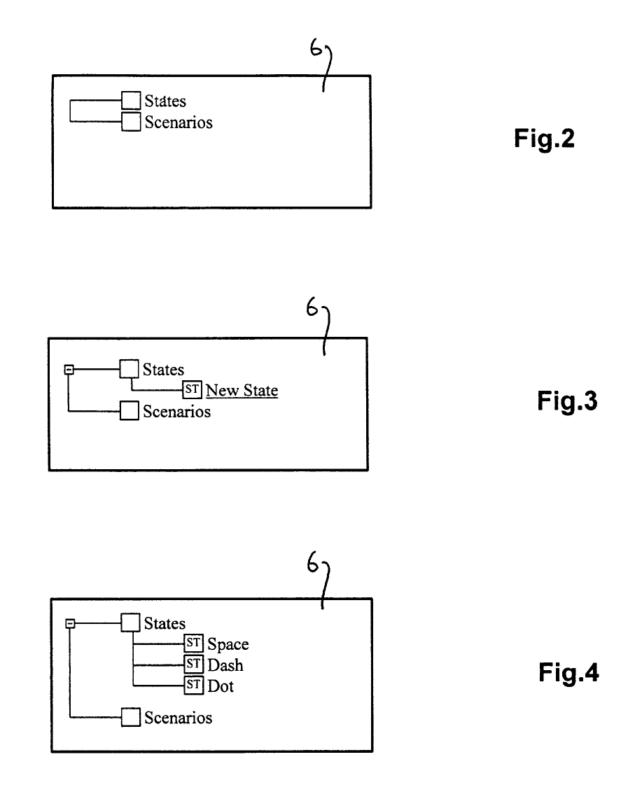

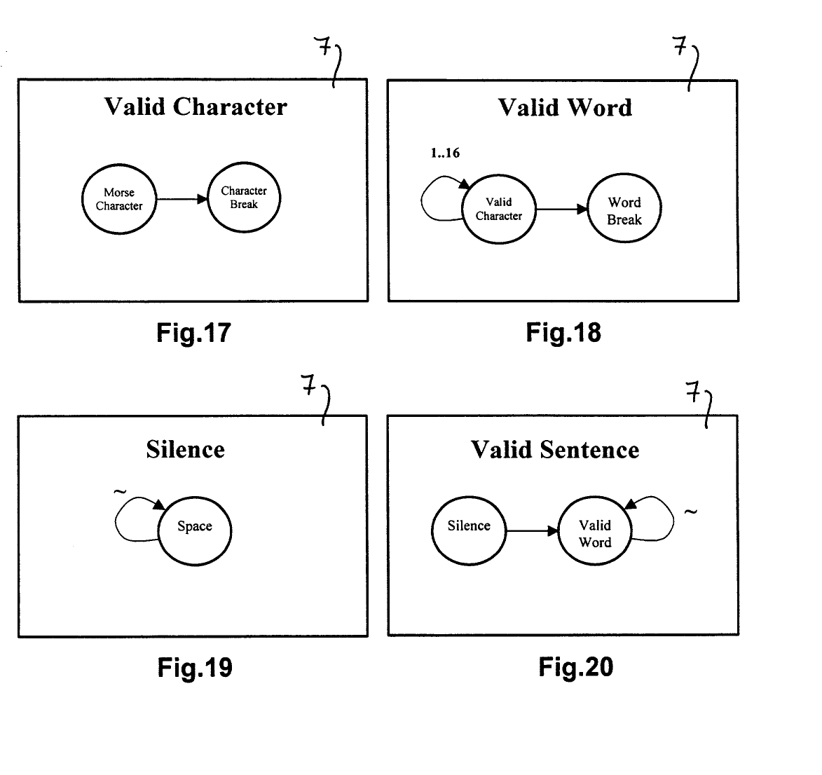

FIGS. 2 to 24 illustrate successive stages in the use of the program.

A computer system according to the embodiment of the invention comprises a conventional PC having a system unit, input devices such as a mouse and keyboard, and output devices such as a printer and monitor. The computer system also includes the computer program now to be described with reference to the drawings loaded onto the hard drive of the system unit. The program runs under the Windows™ 95 operating system. Although only the front-of-screen characteristics of the program are shown and described, it will be well understood by those skilled in the programming art that the program can be implemented in Visual Basic or other programming language by a competent programmer. It will be understood that the program could be implemented in other programming languages such as C++ or JAVA and designed to run on other operating systems.

Referring first to FIG. 1, when the program is run the user is presented with a graphical display on the computer screen, comprising an application window 1 containing menus 2, a toolbar 3, a child window 4 (which can be maximised to fill the application window) and a status bar 5. These elements are standard in the Windows™ 95 graphical interface and need no further description. The child window 4 has left and right panes 6 and 7 respectively.

The left pane 6 is referred to herein as Pattern Explorer and behaves like the Windows™ Explorer utility. The Pattern Explorer contains a hierarchical description of basic pattern elements and patterns in a standard tree structure. Thus it contains branch nodes 8 and leaf nodes 9. A branch node 8 has a number of children which may be subsidiary branch nodes or leaf nodes, while a leaf node 9 is a tree node that doesn't contain any children. A branch node may have a specific graphical element associated with it such as FG, PG shown in FIG. 1, and likewise a leaf node 9 may have a specific graphical element associated with it such as ST, SP. A branch node may be collapsed, meaning that it's children are not visible or expanded, meaning that it's children are visible. This is effected by a view control element 10 visible on a branch node. If the view control element 10 contains a [+] symbol it means that the node's children are invisible and clicking on this element with the mouse will expand the branch node. If the view control element contains a [−] it means that the children are visible and clicking on this element with the mouse will collapse the branch node. The user can select any node on the tree to highlight it, as seen for the leaf node ‘B’ (highlighting is shown by underlining in the drawings). The user is also able to rename any node with standard techniques.

It will be understood that the names shown against the nodes in FIG. 1 are derived from the use of the program to analyse a hypothetical Morse code state machine, as will be described later. Thus, in that context the basic pattern elements are the possible states of the state machine and are labelled as such (Space, Dot, Dash). In general, however, the basic pattern elements are the fundamental elements from which all patterns are built, and may be states of a state machine or other elemental data according to context.

The user may specify the following types of elements in the Pattern Explorer:

State Definitions (identified as ST in FIG. 1)—these are (in this embodiment) the names of different possible states of a hypothetical Morse code state machine and are the basic elements from which patterns may subsequently be build. They are conveniently grouped under a branch node ‘States’.

Pattern Definitions (PD)—these are the names of patterns, and are of two types referred to herein as low level patterns and high level patterns. A low level pattern consists entirely of states (basic pattern elements) while a high level pattern consists of one or more other patterns and, optionally, one or more states. The pattern itself is defined in the right pane 7, as will be described. The pattern can either be a pattern sequence or a pattern equation (see below).

Functional Groups (FG)—these are convenient containers for holding different groups of pattern definitions.

Pattern Groups (PG)—these are the names of pattern templates. A template contains one or more states and/or one or more patterns and all possible transitions between them. A pattern template allows the user to specify individual patterns by selection from the template.

Sub-Pattern Definitions (SP)—these are the names of patterns which can be specified by selection from a Pattern Group (template). The user doesn't draw any states/patterns but uses those defined in the Pattern Group. It is a quick way to arrive at a Pattern Definition.

User Actions for Pattern Explorer are:

New—the user can add new Functional Groups, Pattern Definitions, Pattern Groups, Sub-Pattern Definitions and States by using a menu or a toolbar button or pressing the ‘insert’ key. The currently selected node dictates what the options are, e.g. the user can only create Sub-Pattern Definitions within a Pattern Group.

Delete—the user can delete any node (and it's corresponding children) by using the menu or toolbar or pressing the ‘Delete’ key.

Rename—the user can change the name associated with any node. This is done using the standard Windows™ Explorer rename technique.

Edit—if a user clicks on any Pattern Definition, Pattern Group, Sub-Pattern Definition or State then that item is shown in graphical form in the right pane 7. The user can edit it there.

Send State—if the user double-clicks on a state, that state is inserted into the pattern diagram. This can speed up the pattern specification process.

The right pane 7 is referred to herein as the Pattern Diagram Area. This is an area which displays states or pattern diagrams, the currently displayed state or pattern diagram being that associated with the currently highlighted node in Pattern Explorer (in the drawings highlighted nodes have their associated text underlined). The user may interact with (edit) the Pattern Diagram Area, as will be described. The Pattern Diagram Area contains a label 12 which is the name of the state or pattern diagram being viewed or edited. It also contains one or more bubbles 13 each representing a pattern or a state. These can be moved by the user. It may also contain one or more transition arrows 14 representing a transition from one bubble to another and iteration arrows 15 representing a transition from a bubble to itself. Transition text 16 may be associated with a transitions and iterations. It can either be transition sequences (numeric order of transitions) or iteration constraints. Bubble text 17 is contained in each bubble and is the name of state or pattern represented by the bubble.

The main function of the Pattern Diagram Area is to specify patterns. Patterns are named in Pattern Explorer in the left pane 6 and the right pane 7 is initially blank. The user drags States and/or Pattern Definitions from Pattern Explorer into the Pattern Diagram Area and links them together by arrows 14 and/or 15 to create patterns.

Patterns can either be Pattern Sequences or Pattern Equations. A Pattern Sequence is where the patterns/states are connected to each other by arrows 14. This means that the patterns/states in the pattern follow each other in a particular sequence, e.g. A→B→C→D. A Pattern Equation is where the patterns/states in the pattern have no connection between them, i.e. they are ORed.

An iteration is indicated by an arrow 15 and is where a single pattern or state can be sequenced a number of times. This is determined by a pattern constraint identified by transition text 16 beside the arrow 15. A pattern constraint can either be nothing, a symbol e.g. ‘˜’ denoting that any number of iterations can occur, a single number, a range or a combination of the last two, e.g. (1, 4 .. 5, 7), meaning 1 or 4 to 5 or 7.

Having specified all the states and patterns which the user wishes to use in his analysis, the program allows the user to select any high level pattern, i.e. a pattern consisting of one or more other patterns and, optionally, one or more states, for compilation. Compilation involves the program analysing the selected pattern and building a hierarchical tree in which all the leaf nodes are states and all the branch nodes are contributory patterns of the selected pattern. Bearing in mind that high level patterns are built up from other patterns, and those other patterns may be built up from yet further patterns, and so on, a contributory pattern is a pattern which directly or indirectly contributes to the pattern being compiled. Ultimately, of course, each high level pattern has to be resolved, through its contributory patterns, into a sequence of states and, therefore, essentially the hierarchical tree identifies all possible paths from the selected pattern to each state contributing, directly or indirectly, to the selected pattern.

This hierarchical tree is displayed both in Windows™ Explorer-like fashion in the left pane 6 as well as being stored on the computer as a hierarchically structured data file. An example of a compiled hierarchical tree will be described later with respect to the example which follows.

FIGS. 2 to 24 illustrate the use of the program in the case of a hypothetical Morse code state machine.

Morse code is a language composed of dots, dashes and spaces. These are the basic pattern elements (or states) which when combined together produce English characters and punctuation marks which in turn make up words and sentences.

A=Dot, Space, Dash, Space

B=Dash, Space, Dot, Space, Dot, Space, Dot, Space

C=Dash, Space, Dot, Space, Dash, Space, Dot, Space

Z=Dash, Space, Dash, Space, Dot, Space, Dot, Space,

0=Dot, Space, Dash, Space, Dash, Space, Dash, Space, Dash, Space

FullStop=Dot, Space, Dash, Space, Dot, Space, Dash, Space, Dot, Space, Dash, Space

A character break=three spaces

A word break=seven spaces

The following is an example of specifying the functional dynamics of Morse code using the program.

Step 1: Identify and define the lowest level elements as states.

The following list contains the simplest elements or building blocks used in Morse code:

Dash

Dot

Space

A new window 4 is opened which results in the Pattern Explorer display shown in FIG. 2. The user runs the ‘New State’ command, and the program creates a child node of the States node, FIG. 3. The user renames the ‘New State’ to ‘Space’. The other two states are created and renamed ‘Dash’ and ‘Dot’ respectively. The resultant Pattern Explorer is shown in FIG. 4.

Step 2: Create a pattern hierarchy.

A pattern hierarchy is created by looking at the data from a higher level of abstraction and identifying a pattern hierarchy. For example Morse code consists of dots, dashes and spaces, put together they can define different elements such as alpha characters, numeric characters, punctuation characters. These in turn can build higher level definitions such as words, sentences, paragraphs, etc. This is specified as follows.

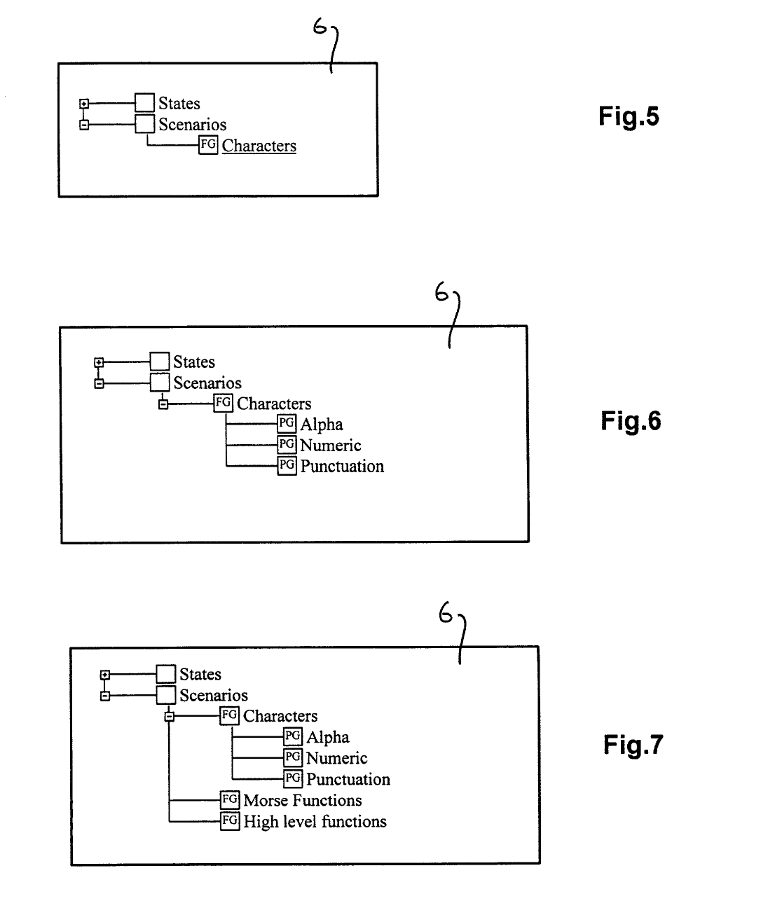

The user creates a Functional Group called ‘Characters’, FIG. 5. This is done by running a command called ‘New Functional Group’ and entering the text ‘Characters’. In FIG. 5 the ‘States’ node is collapsed. This is done to hide data that is not currently important to the user.

From analysis, the Functional Group ‘Characters’ can be split into three distinct types of groups: ‘Alpha’, ‘Numeric’ and ‘Punctuation’. As there will be many different patterns within each of these groups, it is more efficient to create each of these groups as a Pattern Group. This is done by running the command ‘New Pattern Group’. FIG. 6 shows the Pattern Explorer when this has been done.

Before the Sub-Patterns are created for each of these Pattern Groups other Functional Groups are desirable, e.g. a Functional Group for some of the Morse functions e.g. character break, word break etc. This is called ‘Morse Functions’. Another group that is needed is one for the higher level functions such as ‘Valid Character’, ‘Valid Word’, etc. This is called ‘High level functions’. FIG. 7 shows the resulting Pattern Explorer.

Step 3: Specify Pattern Definitions

Step 2 involved setting up an intuitive hierarchy for the different functions of Morse code. The present step involves the specification of related patterns. Close analysis of a Morse sequence will show that all of the characters are composed of dot, space, dash, space, etc. so we can save time by creating a ‘Dot Sequence’ and a ‘Dash Sequence’ as follows.

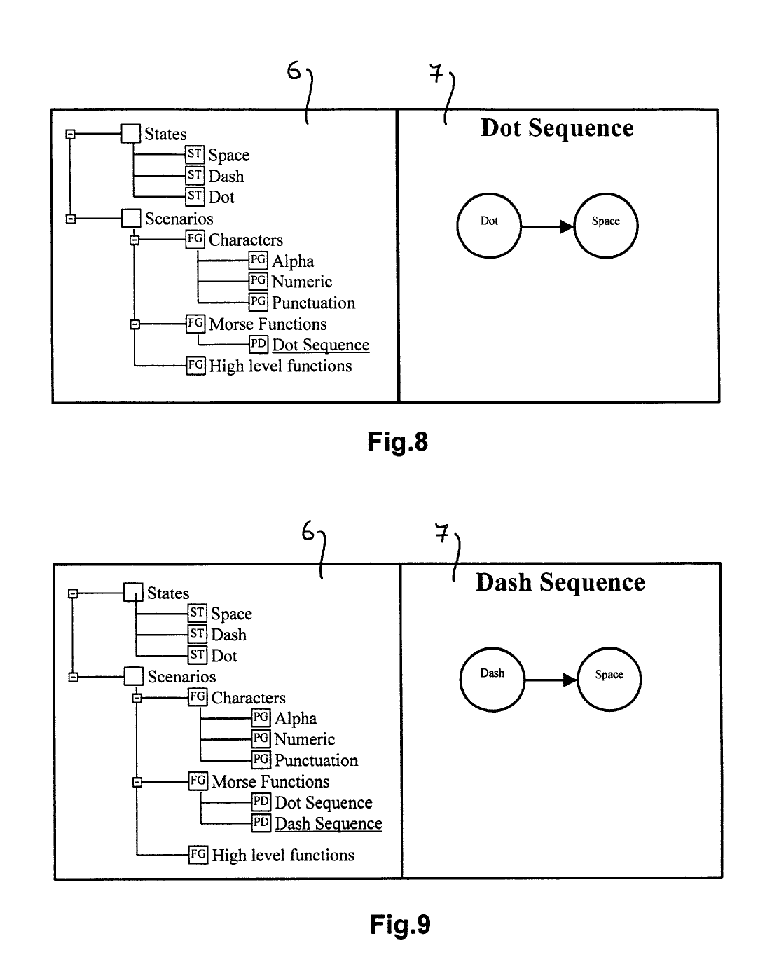

To create a Dot Sequence the node ‘Morse Functions’ Functional Group is selected and a ‘New Pattern’ command is run. This creates a new Pattern Definition within this functional group. This is renamed to ‘Dot Sequence’. The ‘Dot’ State is then dragged from the Pattern Explorer pane 6 and dropped onto the Pattern Diagram Area 7. This automatically creates a bubble with the selected State's name. The same action is repeated for the ‘Dash’ State and the user connects these together in a sequence. The resultant pattern diagram is shown in FIG. 8. Similarly one creates a Dash Sequence as shown in FIG. 9.

The Dash Sequence and Dot Sequence patterns could be used directly to build up patterns corresponding to respective letters of the alphabet, but this is more efficiently done by first specifying a template pattern for the Pattern Group ‘Alpha’ and then specifying the individual letter patterns by selection from this.

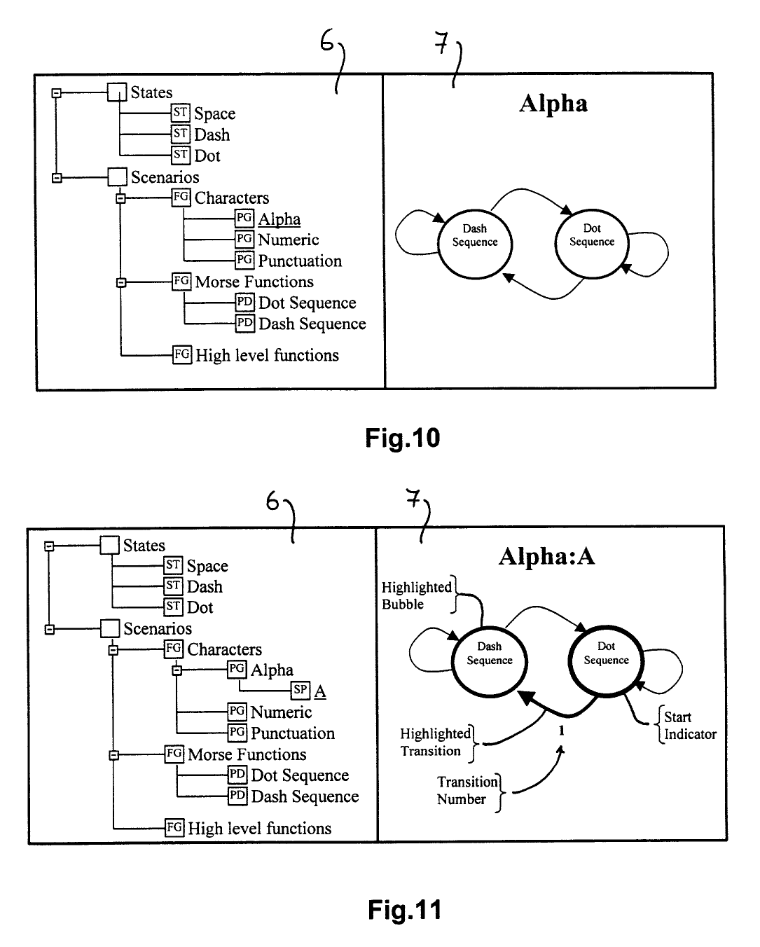

The template for Alpha is shown in FIG. 10. This can be created by dragging the patterns ‘Dot Sequence’ and ‘Dash Sequence’ from Pattern Explorer to the Pattern Diagram Area and connecting these by transition arrows.

Because ‘Alpha’ is a Pattern Group, the user can now define sub-patterns using this template. This is done by running the command ‘New Sub-Pattern’. This creates a new sub pattern which the user renames to ‘A’. The screen shows the Alpha template and awaits user input to specify the sub-pattern definition.

To define sub-patterns, the user runs a command called ‘Add new sequence’. This allows the user to define a sub-pattern using the Alpha template. The sub-pattern is created by the user clicking on the different patterns and transitions in the proper sequence for the sub-pattern being specified. The program highlights the nodes and transitions used in the sequence. Thus the pattern ‘A’ is ‘Dot Sequence’ followed by ‘Dash Sequence’ and the resulting screen is shown in FIG. 11.

Although the template remains in view, the selected pattern sequence can be identified by starting at the bubble indicated by the start indicator (very heavy line) and following each transition number sequentially. All used bubbles are also highlighted.

The sub-pattern for B (Dash Sequence, Dot Sequence×3) is similarly specified from the Alpha template, and the result is shown in FIG. 12.

All the characters from A to Z are specified in this way. This completes the Alpha definition. The patterns for the numbers and punctuation can likewise be derived from the Numeric and Punctuation templates in a similar way. The Numeric and Punctuation templates can be copied from the Alpha template, although in general it is not necessary for all Pattern Group templates to be the same and they could be individually created.

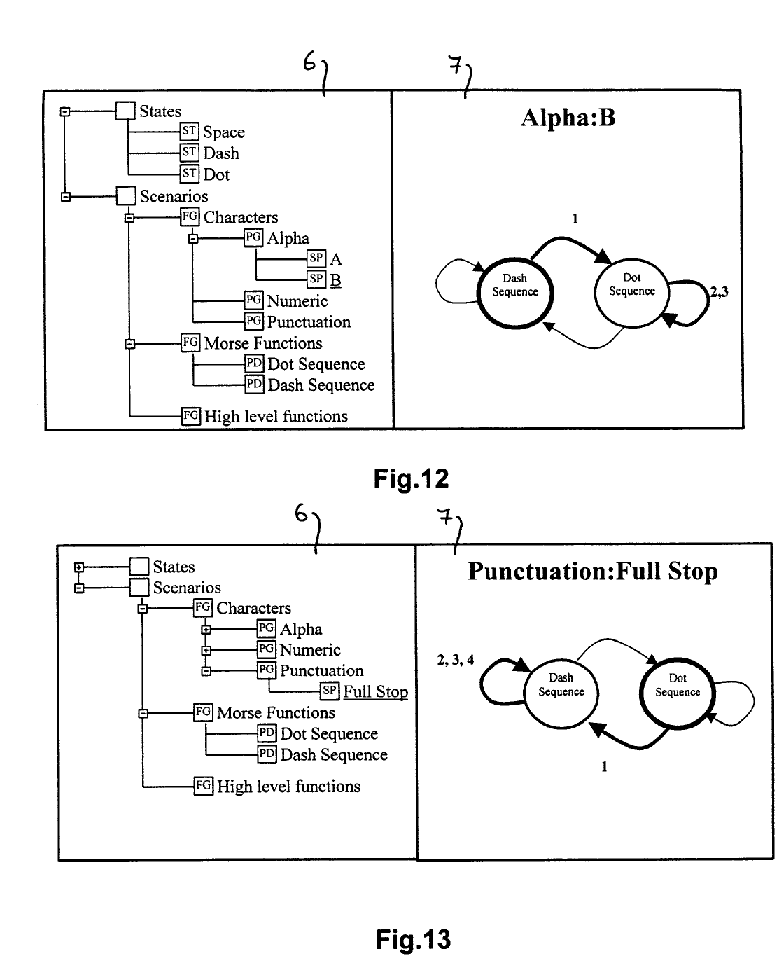

As an example, FIG. 13 shows the screen after the creation of the Full Stop pattern from the Punctuation Pattern Group.

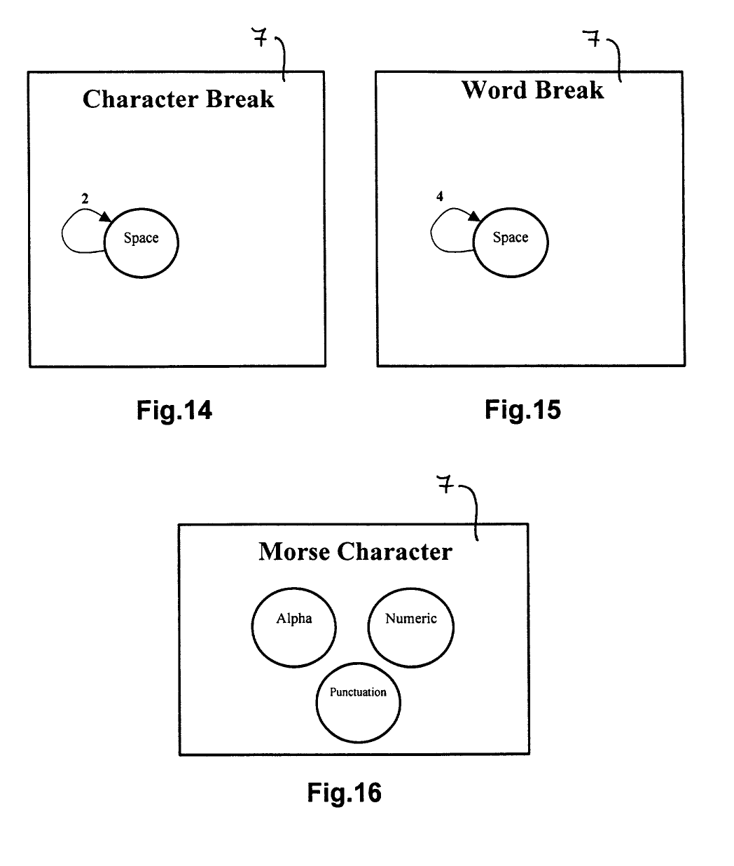

Next, the ‘Character Break’ and ‘Word Break’ patterns are created in the ‘Morse Functions’ Functional group. These are created using the techniques already described and the resulting views in the Pattern design Area are shown in FIGS. 14 and 15. The reason the Character Break pattern is not 3 spaces is because all of the Character Functional Group end in a space and therefore when this pattern is added, the number of spaces will become 3. Similarly a Word Break pattern may follow this so this will end up to be 7 spaces.

At this stage now, the user can define the high-level patterns ‘Morse Character’, ‘Valid Character’, ‘Valid Word’, ‘Silence’ and ‘Valid Sentence’, FIGS. 16 to 20. Each is created by dragging the relevant patterns or, the case of the Morse Character, Pattern Groups, from Pattern Explorer to the Pattern Design Area and connecting them as necessary.

In the case of the Morse Character pattern, by not connecting the Pattern Groups the user is creating parallel sequences. In other words

Morse Character=‘Alpha’ or ‘Numeric’ or ‘Punctuation’.

If, as in this case, a Pattern Group is used in a pattern definition, all the sub-patterns of this group are ORed. Thus the total equation for Morse Character would be:

[A] or [B] or .. or [Z] or [0] or [1] or .. or [9] or [Full Stop] or [Comma] . . . or [colon].

The Valid Character pattern is the Morse Character pattern followed by a Character Break pattern. The Valid Word pattern is any number of Valid Character patterns from 1 to 16 followed by a word break.

The Silence pattern is necessary because there may be no transmission at the start. The Silence pattern consists of any number of Space states. Finally, the Valid Sentence pattern is the Silence pattern followed by any number of Valid Word patterns.

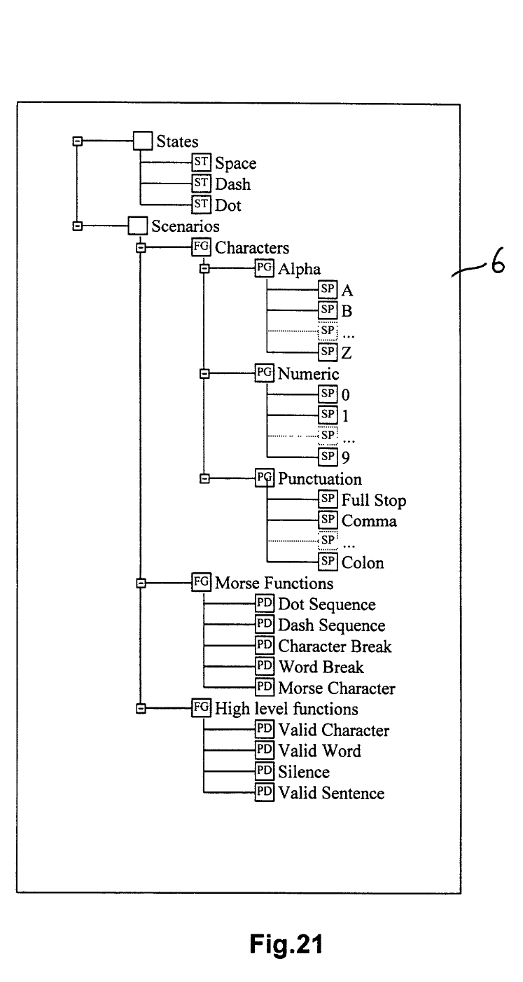

This completes the pattern specification. The corresponding view in Pattern Explorer is shown in FIG. 21 with all nodes expanded.

Step 4: Compile Patterns

Now, by selecting (highlighting) any of the patterns defined in Pattern Explorer, i.e. any of the nodes SP or PD, and running a ‘Compile’ command, the program will analyse the selected pattern (referred to now, when selected for the purpose of compilation, as the master definition) and build a hierarchical tree in which all the leaf nodes are states and all the branch nodes are contributory patterns of the selected pattern, as previously described. The tree is displayed in Pattern Explorer as well as being stored on the computer as a hierarchically structured data file.

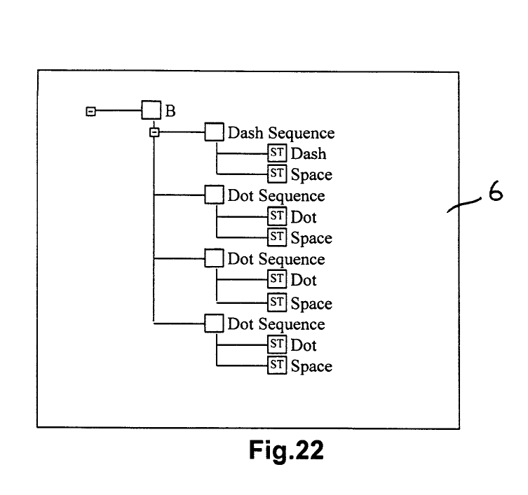

For example, the ‘B’ pattern is defined as Dash Sequence, Dot Sequence, Dot Sequence, Dot Sequence, and the corresponding compiled hierarchical tree is shown in FIG. 22.

This object structure is very beneficial for pattern coverage in that it can be used to distinguish between a standard ‘Dot sequence’, that can occur many times throughout a Morse sequence, and a specific ‘Dot sequence’ that can occur within specific confines e.g. the first ‘Dot Sequence’ of the ‘B’ pattern.

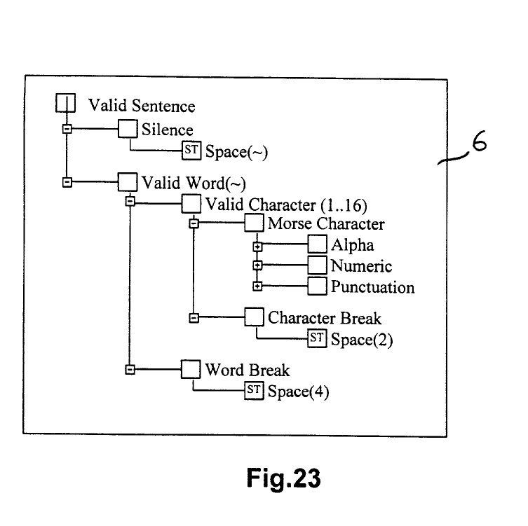

FIG. 23 is an example of a compiled pattern with ‘Valid Sentence’ as the master definition. Note that the compiled pattern contains over 300 nodes and FIG. 23 therefore shows the compiled pattern with the Alpha, Numeric and Punctuation patterns collapsed.

Note that there are two types of patterns which exist in the compiled pattern—sequences and equations. Valid Word, for instance, is a sequence of Valid Character(1 .. 16) followed by Word Break whereas Morse Character is an equation, i.e. Alpha Or Numeric or Punctuation. This may or may not be differentiated on the computer screen.

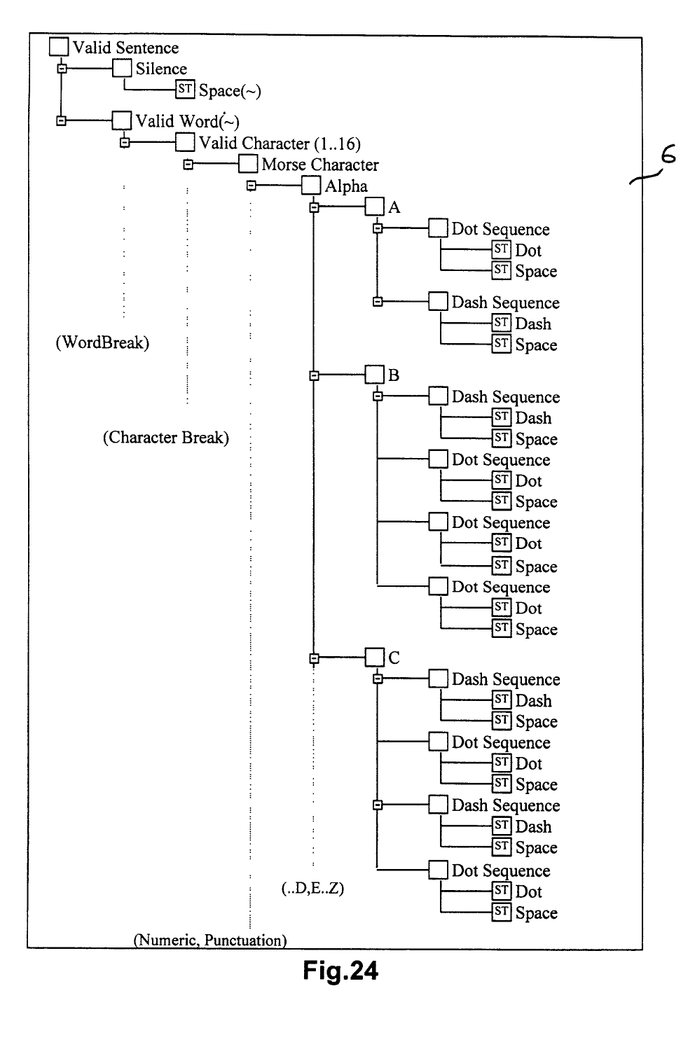

FIG. 24 is an expanded version of the compiled Valid Sentence pattern which shows the Alpha pattern expanded. Again, as there are 100's of nodes, this is an abbreviated version. The user can see the whole tree on the screen by using scrollbars and/or collapsing and expanding the nodes.

It will be seen that variations and extensions to the above described embodiment are possible. For example, the invention can encompass auxiliary patterns which are patterns within a sequence which constrain a pattern definition without being part of the actual sequence. An example of this auxiliary pattern could be a pattern for the morse code ‘E’. This is a single dot. However, within a morse code sequence there are many single dots which are not ‘E’s so adding auxiliary patterns before and after E we get:

E:={Break} DOT {Break}

This means that E is defined as a DOT between two breaks, but the DOT is still the only place where E is valid. This allows a user to create clearer definitions of patterns.

Further modifications of the invention are also possible, for example, instead of waiting until the user actually selects a pattern to compile, the invention is also applicable to compiling the pattern dynamically each time the user alters a data pattern.

Also, although the foregoing has described a single level of functional groups FG in Pattern Explorer, it is clearly possible for the user to specify a hierarchy.

Although the foregoing has described the embodiment of the invention used for the relatively simple case of the analysis of a hypothetical Morse code state machine, it will be readily understood by those skilled in the art that the invention is suitable for use in the analysis of far more complex situations such as those arising from the analysis of state machine transitions in hardware simulation techniques.

The invention is not limited to the embodiment described herein which may be modified or varied without departing from the scope of the invention.

1. A computer system for defining and analysing data patterns, the system comprising means to enable a user to specify, by interaction with a graphical display on a computer display screen:
(a) a plurality of different basic pattern elements, and
(b) a plurality of different patterns including low level patterns which contain only one or more basic pattern elements and high level patterns which contain one or more other patterns and, optionally, one or more basic pattern elements, the user also being able to specify allowable transitions, if any, between the basic pattern element(s) and/or pattern(s) in a pattern,
the system further including means for compiling any such pattern into a hierarchical tree wherein all leaf modes are basic pattern elements and all branch nodes are contributory patterns.

2. A computer system as claimed in claim 1 wherein such patterns are selected by the user.

3. A computer system as claimed in claim 1 wherein such patterns are compiled dynamically.

4. A computer system as claimed in claim 1, which further enables the user to specify a plurality of different pattern groups each containing one or more basic pattern elements and/or one or more patterns and all possible transitions between them, and to specify patterns by selecting basic pattern elements and/or patterns, and desired transitions between them, from a pattern group.

5. A computer system as claimed in claim 4, which further enables the user to include one or more pattern groups in a pattern, the user also being able to specify allowable transitions, if any, between the pattern group(s) and any basic pattern element(s) and/or pattern(s) in that pattern.

6. A computer system as claimed in claim 1, which further enables the user to specify a hierarchy of classification groups each containing patterns or classification groups of a lower level in the hierarchy.

7. A computer system as claimed in claim 1, wherein in the absence of transitions in a pattern the basic pattern element(s) and/or pattern(s) and/or pattern group(s) in that pattern represent a pattern equation.

8. A computer system as claimed in claim 7, wherein the pattern equation is an OR function.

9. A computer system as claimed in claim 1, wherein the graphical display comprises a window including two panes, a first of the panes displaying the basic pattern elements and patterns in a hierarchical tree and the second pane displaying any pattern currently selected in the first pane as one or more editable annotated graphical objects.

10. A computer program comprising program code recorded on a computer readable medium, such code when run on a computer causing the computer to enable a user to specify, by interaction with a graphical display on a computer display screen:
(a) a plurality of different basic pattern elements, and
(b) a plurality of different patterns including low level patterns which contain only one or more basic pattern elements and high level patterns which contain one or more other patterns and, optionally, one or more basic pattern elements, the user also being able to specify allowable transitions, if any, between the basic pattern element(s) and/or pattern(s) in a pattern,
the code further including means for compiling any such pattern into a hierarchical tree wherein all leaf modes are basic pattern elements and all branch nodes are contributory patterns.
